(19) United States
(12) Patent Application Publication
(10) Pub. No.: US 2025/0166100 A1
(43) Pub. Date: May 22, 2025

(54) SYSTEMS AND METHODS FOR VIRTUAL TOURS OF REAL ESTATE PROPERTIES

(71) Applicant: Planitar Inc., Waterloo (CA)

(72) Inventors: Alexander Likholyot, Kitchener (CA); Jarrad Vincent Morden, Waterloo (CA); Skylar Garry John Andrew Lawrence-LeBel, Waterloo (CA)

(21) Appl. No.: 18/894,167

(22) Filed: Sep. 24, 2024

Related U.S. Application Data
(60) Provisional application No. 63/599,840, filed on Nov. 16, 2023.

(51) Int. Cl. G06Q 50/16; G06Q 30/0601; H04N 23/698

(52) U.S. Cl. CPC G06Q 50/16; G06Q 30/0643; H04N 23/698

(57) ABSTRACT

Systems and method for providing virtual tours of real estate properties are disclosed. The system provides a virtual tour at a user device including a plurality of images of a real estate property and a virtual tour guide that provides information corresponding to the images that are displayed in the virtual tour. The virtual tour guide may include audio guide components, video guide components and text guide components. In some embodiments, buyer preference information is used to determine the order in which images are presented during the virtual tour. In various embodiments, buyer preference information may be obtained prior to a virtual tour, during a virtual tour or both.

### CROSS-REFERENCE TO RELATED APPLICATION

This application claims the benefit of U.S. Provisional Application No. 63/599,840 filed on Nov. 16, 2023, which is incorporated by reference herein in its entirety.

### FIELD

The described embodiments relate to systems and methods for providing a viewer, such as a potential buyer, lessee, renter, renovator, or other user with interest in a real estate property with a virtual tour for viewing the property.

### INTRODUCTION

Omnidirectional images have been used in real estate sales for many years. A typical use of omnidirectional imagery is to provide a collection of images taken in various locations through a property as part of a real estate listing. A user may view each image to learn more about that location, such as a room, hallway, or other part of the property. A typical omnidirectional image may be rotated in at least one dimension, typically horizontally, to see 360° around the location. Some images may also be rotatable in a vertical dimension to allow a user to view, for example, the ceiling or floor in a location. Such omnidirectional images are intended to allow immersive viewing of the location by allowing a user to change a viewing direction, i.e., change azimuth and elevation angles to look around or up/down when viewing such an image and to transition from image to image. In some cases, a user may also be able to change the camera zoom to view a particular portion of the omnidirectional image in greater detail.

The use of images in general, including omnidirectional images, in real estate sales is limited by the quality of the experience they provide. While omnidirectional images can provide more information to a viewer than a typical 2D image, they still require a viewer to manually manipulate viewing direction and zoom level, and ultimately provide a manual user operated experience. They do not provide for a cohesive viewing experience of the property.

The current adoption of virtual tours and methods for conducting virtual tours of properties remains low, at least in part, because of a lack of a market feedback mechanism to collect feedback on the viewed property.

There is a need for an improved system and method for providing a virtual tour of a property. Additionally, there is a need to enable the collection of market feedback from a viewer of a property.

### SUMMARY

The various embodiments described herein generally relate to systems and methods for providing virtual tours of real estate properties. The virtual tours include a collection of images of various locations at the property, including rooms within and around the property. A virtual tour system includes a virtual tour server and various user devices on with a virtual tour may be presented in a virtual tour application, a browser or other software.

A virtual tour of a property may include a sequential tour of locations within the property presented in order together with a virtual tour guide that may include information components such as audio, text and video guide components. The virtual tour guide may include a visual avatar or other visual element to guide a viewer through the virtual tour. The avatar may be based on a human real estate agent, may be a generic image, animated or a graphic image. The avatar may be adapted to appear and move in a life-like manner to correspond to the behavior and appearance of a real estate agent.

The virtual tour system allows a real estate agent or other person to assemble images of a real estate property into a virtual tour. In some embodiments, a plurality of tours may be configured for a property and a viewer may be presented with a tour based on the viewers, demographics, behavior, interests and other characteristics. In some embodiments, a dynamically created tour may be presented to the viewer based on the viewer's characteristics.

Data for a virtual tour for a real estate property may be stored at the virtual tour server and may be delivered to a virtual tour application for presentation to the viewer. The data may include image and video data about the property that is shown visually to the viewer. The data may also include factual information that is presented to the viewer as part of a virtual tour and may be provided in response to requests from the user.

In some embodiments, the system may include data relating to furnishings and finishes that can be visually presented in images of a property to virtually stage a property to have an appearance that may be of interest to a viewer. In some embodiments, a viewer may be able to control the furnishings and finishes that are displayed to view in images of the property.

In one aspect, there is provided a computer implemented method for providing a virtual tour of a real estate property to a potential buyer of the real estate property, the method comprising: assembling, at a virtual tour server, a plurality of images wherein each image corresponds to a location in the property; transmitting at least some of the images to a user device; presenting, at the user device, a virtual tour of the property by displaying at least some of the images of the real estate property, wherein the virtual tour is presented by a virtual tour guide, and wherein the virtual tour guide includes an audio guide component that includes, when one or more of the images are displayed, a narration corresponding to the displayed images.

In some embodiments, the presentation of the virtual tour includes display of a floorplan of the real estate property, and wherein, when one of the images is displayed, the display of the floorplan includes a marker identifying the location corresponding to the displayed image.

In some embodiments, the virtual tour guide is additionally presented with a video guide component.

In some embodiments, the virtual tour guide is additionally presented with a video guide component, and wherein the video guide component includes an avatar of a person.

In some embodiments, the virtual tour guide is additionally presented with a video guide component, and wherein the video guide component includes a digitally created image of a person.

In some embodiments, at least some of the images are displayed in an order corresponding to buyer preference information corresponding to the potential buyer.

In some embodiments, at least some of the buyer preference information is determined based on inputs provided by the potential buyer during the virtual tour.

In some embodiments, at least some of the buyer preference information is determined prior to the presentation of the virtual tour based on demographic information about the potential buyer.

In some embodiments, at least some of the buyer preference information is determined prior to the presentation of the virtual tour based on the potential buyer's interactions with at least one previous virtual tour of a different real estate property.

In some embodiments, at least some of the buyer preference information is determined based on responses provided by the potential buyer in response to prompts from the virtual tour guide during the virtual tour.

In another aspect, there is provided a computer implemented method for providing a virtual tour of a real estate property, the method comprising: collecting, at a virtual tour server, buyer preference information corresponding to a potential buyer of the real estate property; assembling, at a virtual tour server, a plurality of images wherein each image corresponds to a location in the property; transmitting at least some of the images to a user device; and presenting, at the user device, a virtual tour of the property by displaying at least some of the images in an order based on the buyer preference information.

In some embodiments, the presentation of the virtual tour includes display of a floorplan of the real estate property, and wherein, when one of the images is displayed, the display of the floorplan includes a marker identifying the location corresponding to the displayed image.

In some embodiments, the virtual tour is presented at the user device by a virtual real estate agent, wherein the virtual real estate agent includes an audio guide component.

In some embodiments, the virtual tour is presented at the user device by a virtual real estate agent, wherein the virtual real estate agent includes an audio guide component and a video guide component.

In some embodiments, the order of the images presented during the virtual tour is modified based on the buyer preference information collected during the presentation of the virtual tour.

In some embodiments, at least some of the buyer preference information is collected during the virtual tour by presenting an interactive user interface including a series of prompts and by receiving a series of corresponding answers, wherein the buyer preference information is extracted from the answers.

In some embodiments, the series of prompts is presented in the interactive user interface by a virtual real estate agent, wherein the virtual real estate agent includes an audio guide component.

In some embodiments, the series of prompts is presented in the interactive user interface by a virtual real estate agent, wherein the virtual real estate agent includes an audio guide component and a video component.

In some embodiments, the series of prompts is presented in the interactive user interface by a virtual real estate agent, wherein the virtual real estate agent includes an text guide component.

In some embodiments, at least some of the buyer preference information is determined prior to the presentation of the virtual tour based on demographic information about the potential buyer.

In some embodiments, at least some of the buyer preference information is determined prior to the presentation of the virtual tour based on the potential buyer's interactions with at least one previous virtual tour of a different real estate property.

In another aspect, there is provided a method for providing an virtual tour of a real estate property, the method comprising: receiving a collection of omnidirectional images of a property, a floorplan of the property, property information data, and user data, wherein the collection of omnidirectional images provides for moving in virtual space; receiving a tour request via a user device for giving the interactive tour of the virtual space by a virtual property tour guide; determining, based on the property information data and the user data, a virtual tour route of the property to provide the interactive virtual tour; and displaying the virtual tour on the user device.

In some embodiments, the user data is collected by asking the user at least one question and receiving at least one answer to the at least one question.

In some embodiments, the at least one question and the at least one answer are conducted via audio or text.

In some embodiments, determining the virtual tour route of the property further comprises analyzing the at least one answer to the at least one question.

In some embodiments, the property information data is at least one selected from a group of omnidirectional image metadata, floorplan data, and MLS listing data.

In some embodiments, the virtual tour of the property can be given by the virtual property tour guide displayed as an animated photo-realistic avatar.

In some embodiments, the virtual property tour guide can be synthesized from the headshots and optionally other images of a real estate agent.

In some embodiments, the virtual property tour guide gives the virtual tour audibly and uses voice synthesized from a human.

In some embodiments, the user data further comprises data corresponding to user interactions from a previous interactive virtual tour.

In some embodiments, the virtual tour is responsive to interaction requests from the user.

In some embodiments, the interaction request is to change view of the omnidirectional image being shown to the user.

In some embodiments, determining the tour route of the property further comprises analyzing interaction requests.

In another aspect, there is provided a method for enabling an expanded tour of a virtual property, the method comprising: providing at least one basic tour of the virtual property to a user, the at least one basic tour limiting at least one view of the virtual property; detecting at least one user interaction with the basic tour, receiving a contact information for the user and in response, providing at least one expanded tour of the virtual property to the user.

In some embodiments, at least one of the basic tour and the expanded tour is an interactive floor plan tour of the virtual property.

In some embodiments, the contact information is used to schedule a virtual showing of the property.

In some embodiments, the basic tour and the expanded tour show different views of the same property.

In some embodiments, the basic tour and the expanded tour show the same views of the same property. These and other aspects are explained further in the description of various example embodiments.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 shows a system diagram in accordance with one or more embodiments.

FIGS. 2A and 2B show example user interfaces in accordance with one or more embodiments.

FIG. 3 shows another example of a user interface in accordance with one or more embodiments.

FIGS. 4A, 4B, 4C, 4D, 4E, and 4F show another example of a user interface in accordance with one or more embodiments.

FIG. 5 shows a standard route of a virtual tour in accordance with one or more embodiments.

FIGS. 6A, 6B, 6C, 6D, 6E, and 6F show another example of a user interface diagram in accordance with one or more embodiments.

FIG. 7 shows a dynamic route of a virtual tour in accordance with one or more embodiments.

FIGS. 8A and 8B are flowcharts illustrating how a virtual tour may be conducted in accordance with one or more embodiments.

FIG. 9 is a flowchart illustrating another example of a virtual tour with different views in accordance with one or more embodiments.

FIG. 10 shows an example of a basic tour in accordance with one or more embodiments.

A person skilled in the art will understand that the drawings, described below, are for illustration purposes only. The drawings are not intended to limit the scope of the applicants' teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

Various apparatuses or methods will be described below to provide an example of the claimed subject matter. No example described below limits any claimed subject matter and any claimed subject matter may cover methods or apparatuses that differ from those described below. The claimed subject matter is not limited to apparatuses or methods having all of the features of any one apparatus or methods described below or to features common to multiple or all of the apparatuses or methods described below. It is possible that an apparatus or methods described below is not an example that is recited in any claimed subject matter. Any subject matter disclosed in an apparatus or methods described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not to be considered as limiting the scope of the examples described herein.

Various example embodiments are described herein. Numerous specific details are set forth in order to provide a thorough understanding of the example embodiments. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more elements are said to be “coupled”, “connected”, “attached”, or “fastened” where the parts are joined or operate together either directly or indirectly (i.e., through one or more intermediate parts), so long as a link occurs. As used herein and in the claims, two or more elements are said to be “directly coupled”, “directly connected”, “directly attached”, or “directly fastened” where the element are connected in physical contact with each other. None of the terms “coupled”, “connected”, “attached”, and “fastened” distinguish the manner in which two or more elements are joined together.

The terms “an embodiment”, “embodiment”, “embodiments”, “the embodiment”, “the embodiments”, “one or more embodiments,” “some embodiments”, “various embodiments” and “one embodiment” and other similar terms mean “one or more (but not all) embodiments of the present invention(s),” unless expressly specified otherwise.

The embodiments of the systems and methods, and components of the systems and methods, described herein may be implemented in hardware or software, or a combination of both. These embodiments, or portions some components of the embodiments, may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. The programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

The described embodiments that follow relate to systems and methods for conducting a virtual tour of a property. The virtual tour may be viewed by a viewer and provided by a virtual tour guide. By way of example, the virtual tour systems and methods disclosed herein can be used in industries such as real estate, insurance, restoration, architecture, construction, facility/property management, and hospitality to allow a viewer to assess a property for various purposes. For example, an insurance agent may view a virtual tour to assess a property under construction, a property that has been damaged or a property that is being repaired. An architect may assess a property (including an unimproved property on which no building has been built) to assess whether a particular building design is suitable for the property. A potential renter of a banquet hall may view a virtual tour to assess whether the banquet hall and its facilities meet their requirements.

A virtual tour may include a depiction of a virtual tour guide, such as a virtual real estate agent, to direct the viewer through a series of images of a real estate property. The virtual tour guide may provide details of the property being toured and other details that may enhance the virtual tour for the viewer. The virtual tour guide can be a digital representation, such as an avatar, of a particular human person or a digital representation of a generic or animated human person. In some embodiments, the virtual tour guide may be provided as a bidirectional or unidirectional interactive or non-interactive audio tour guide, either with or without a visual representation of the tour guide for some or all the virtual tour. For example, in some embodiments, the tour guide may include a verbal or spoken word audio component. In some embodiments, verbal or spoken word audio may model or emulate natural human speech patterns such as language, accent, timbre or tone, pace, and other similar patterns. For example, in some embodiments the visual representation may model or emulate human physical interactive characteristics such as body-language, head, mouth, eyes, limbs, and body movements, mannerisms, and other similar patterns. In some embodiments, the virtual tour guide may be provided in text form, instead of or in addition to a visual or audio representation of the tour guide (or both a visual and an audio representation).

The virtual tour of the property may be provided using a collection of omnidirectional images of locations in the real estate property. Each image will typically include a 360-degree view of a location, such as a room or portion of the real estate property. Typically, only a portion of the 360-degree image is displayed at one time and the image can be moved, panned, and zoomed horizontally to view additional parts of the location. In some embodiments the image may be spherical such that it can be vertically tilted to view higher or lower parts of the room such as a ceiling or floor. Typically, such omnidirectional images may be formed by stitching together hemispherical images or other partial images of the location.

Interacting with one such image is essentially a 2D experience, because there are two degrees of freedom that can be exercised by the viewer user when interacting with any particular image. A collection of such omnidirectional images can optionally be configured to include image poses (position and orientation) of each image in a common coordinate system and, therefore, with respect to each other. Such a configured collection of panoramic images will allow an immersive experience of moving through 3D space, when a transition from image to image can be affected by user via choosing a transition direction and another image is shown whose pose with respect to the first image is the closest to the selected transition direction, thus, adding a 3rd degree of freedom to create a virtual touring experience. In some embodiments, if there is sufficient overlap between the respective images, a 6DoF transformation between the images may be calculated and displayed to simulate movement between the locations.

In some embodiments, the virtual tour may include video data in addition to omnidirectional images. A viewer may be presented with an omnidirectional image to viewing a particular location within a property. When the virtual tour moves from one location for which there is an omnidirectional image to another such location, a transitional video may be played (optionally at a controlled speed to correspond to the speed of the tour) depicting movement between the two locations. This may provide a more virtual tour experience for the user that more closely mimics actually walking through the real estate property.

A virtual tour for a property may use omnidirectional images of the property to allow a viewer to explore and navigate through the property. A virtual tour may offer a more immersive and interactive experience than clicking through an image library by allowing the user to interact with the property in the tour more freely. Virtual tours allow users to move from room to room examining details and getting a sense of the spatial layout. A virtual tour may also incorporate multimedia elements to enhance the comprehensive understanding of the property.

In some embodiments, to aid navigation of a virtual tour, the omnidirectional images may be supplemented with a floorplan (or floorplans for multilevel properties) of the property being toured. A floorplan can be included in the virtual tour and may be synchronized with the collection of the omnidirectional images such that a location of the currently viewed omnidirectional image is shown on the floor plan. Further, transition to another image can be affected by selecting a new location on the floorplan.

In some embodiments, a visual transition between one omnidirectional image and another omnidirectional image may be presented as a smooth transition simulating a person walking within the real property from the location of the first image to the location of the second image. For example, if there is sufficient overlap between the first and second images, a 6DoF transformation between the images may be calculated and displayed to simulate movement between the locations.

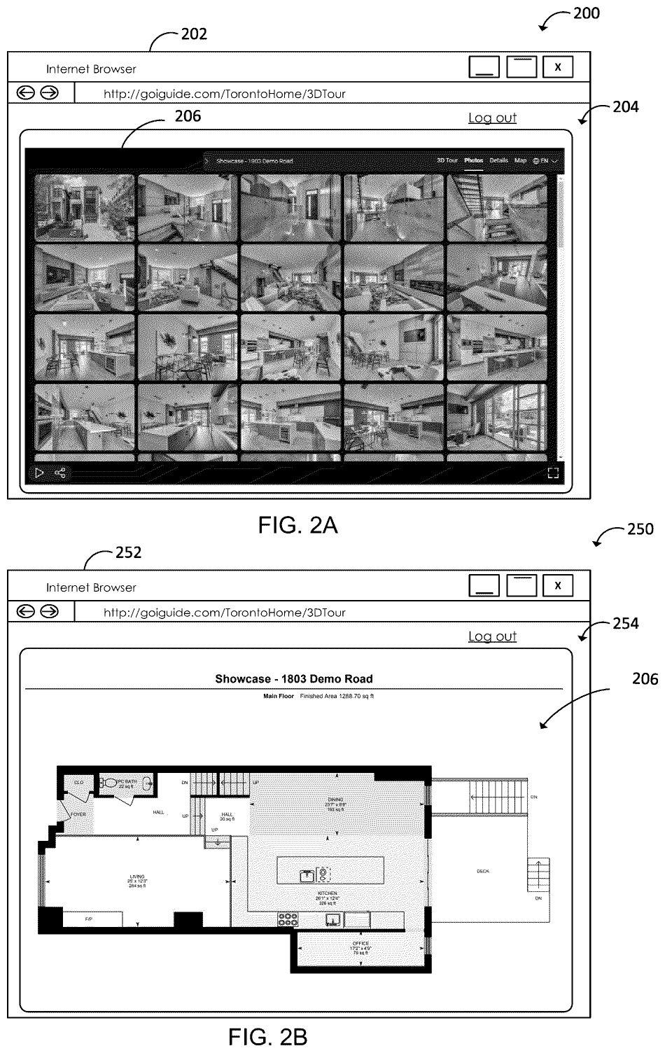

Examples of omnidirectional images are shown in FIG. 2A. Each of the omnidirectional images allows for immersive viewing of a location in the real estate property by allowing a viewer, such as the potential buyer, to change a viewing direction, i.e., rotated horizontally or vertically to look around or up/down when viewing such an image and to transition from image to image, or zooming in and out of the image.

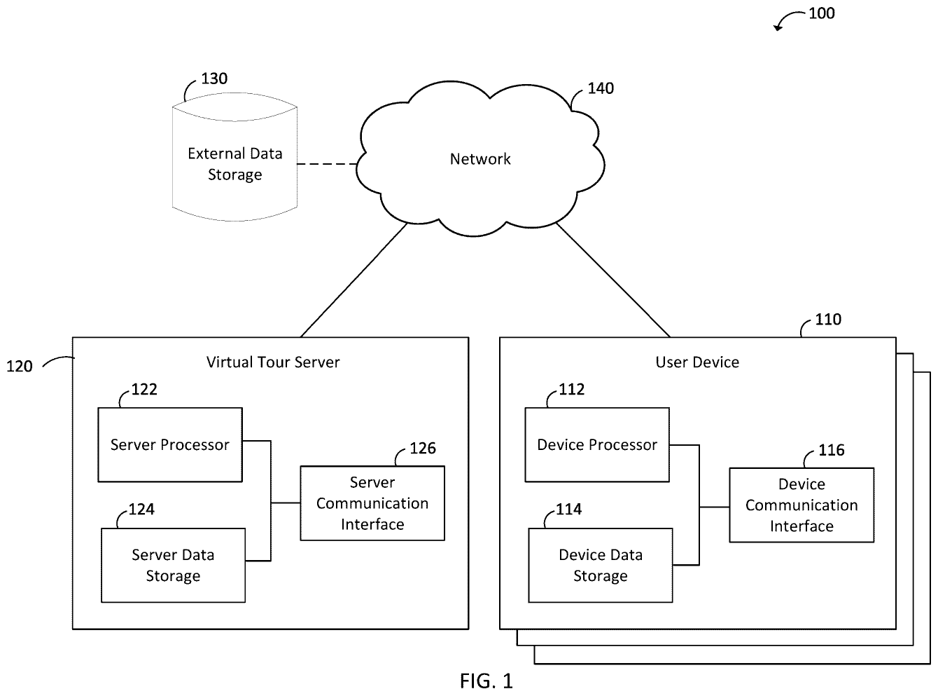

FIG. 1 shows an example of a virtual real estate tour system 100 that includes a virtual tour server 120, user devices 110 and an optional external data storage 130. The server 120, user device 110, and the optional external data storage 130 are in data communication via a communication network 140. The virtual tour server 120 includes a server processor 122, a server data storage 124 and a server communication interface 126. The virtual tour server 120 can be implemented with more than one computer servers distributed over a geographic area and connected via the network 140. The server processor 122, the server data storage 124 and the server communication interface 126 may be combined into fewer components or may be separated into further components. The server processor 122, the server data storage 124 and the server communication interface 126 may be implemented in software or hardware, or a combination of software and hardware.

The server processor 122 can be implemented with any suitable processor, controller, digital signal processor, graphics processing unit, application specific integrated circuits (ASICs), and/or field programmable gate arrays (FPGAs) that can provide sufficient processing power for the configuration, purposes, and requirements of the virtual tour server 120 as will be discussed herein. The server processor 122 can include more than one processor and each processor can be configured to perform overlapping or different dedicated tasks.

The server communication interface 126 can include any wired or wireless interface that enables the virtual tour server 120 to communicate with various computing devices and other systems. In some embodiments, the server communication interface 126 can include at least one of a serial port, a parallel port or a USB port. For example, the server communication interface 126 can receive data from or transmit data to the user device 110 and/or the external data storage 130. The server communication interface 126 may include one or more of an Internet, Local Area Network (LAN), Ethernet, Firewire, modem or digital subscriber line connection.

The server data storage 124 can include RAM, ROM, one or more hard drives, one or more flash drives, or some other suitable data storage elements such as disk drives, etc. The server data storage 124 can, for example, include a memory used to store programs and an operating system used by the virtual tour server 120. The server data storage 124 can include one or more databases for storing information related to, but not limited to, users of the virtual tour server 120 (e.g., real estate agents, sellers, buyers, property managers, insurance adjusters, contractors etc.), and real estate properties, and their corresponding virtual tours.

The optional external data storage 130 can store data like that of the server data storage 124, and/or different data. The external data storage 130 can be used as a back-up data storage and/or for storing larger files which can be retrieved or accessed directly via the network 140, for example Multiple Listing Service (MLS) data or other commercially available real estate databases. The external data storage 130 can, for example, be a network attached storage (NAS) or a cloud storage. The data stored in the external data storage 130 can be accessed by the virtual tour server 120 and/or the user device 110 via the network 140.

The user device 110 can include any computing device that is capable of viewing video and image content. Although only one user device 110 is illustrated in FIG. 1, two or more user devices 110 can be in communication with the other components illustrated in FIG. 1.

The user device 110 can include at least a device processor 112, a device data storage 114, and a device communication interface 116. It should be noted that the device processor 112, the device data storage 114, and the device communication interface 116 may be combined or may be separated into further components. The device processor 112, the device data storage 114, and the device communication interface 116 may be implemented in software or hardware, or a combination of software and hardware.

The device processor 112 controls the operation of the user device 110. The device processor 112 may be any suitable processors. controllers or digital signal processors that can provide sufficient processing power depending on the configuration, purposes, and requirements of the user device 110 as will be described herein. In some embodiments, the device processor 112 can include more than one processor with each processor being configured to perform different dedicated tasks.

A virtual tour may be presented to a user or viewer of the user device 110 through a virtual tour application operating on the user device. Typically, the user device 110 will be in communication with the virtual tour server to retrieve information relating to real estate properties on an ongoing basis.

In some embodiments, the user device 110 may operate as the virtual tour server 120. For example, the virtual tour server 120 may operate locally on a user device. In some embodiments, the virtual tour server could be implemented in as part of a virtual tour application on the user device 110.

In some embodiments, the virtual tour app may operate as a standalone application in which information about selected real estate properties and virtual tours has been loaded. When operating as a standalone application, the functionality of the virtual tour application may be reduced as compared to a cloud-based operation with the virtual tour server 120 via the network 140. For example, when operating as a standalone application, the virtual tour application may not be able to access all data for all real estate properties and their available interactive tours, or all the viewer data.

In various embodiments, the functionality of the virtual tour server, virtual tour application and other components of may be distributed in various ways to provide various functionality. For example, as described below, a viewer may be presented with a virtual tour based on the viewer's demographics. The virtual tour may be modified or supplemented in real time based on the viewer's interests (including the user's questions and interaction inputs during the tour). Similarly, a viewer may be presented with a dynamically generated tour with a route that is determined based on the viewer's interests or behavior. Software components to identify the viewer's interests, demographics and behavior and select and arrange a virtual tour for the user based on those characteristics may be implemented at the virtual tour server, in a virtual tour application or in components provided at both the virtual tour server and the virtual tour application. Similarly, the viewer may be presented with a rendition of images that are modified to depict selected items and finishes in locations in the property, based on the user's demographics, interests and behaviors. Software components to generate such views may be provided at the virtual tour server, the virtual tour application or across both of them. Similarly, the viewer might be presented with a basic tour of the virtual property which may include views of the most presentable areas of the property and the less presentable views of the property hidden. Alternatively, the viewer might be presented with an expanded tour of the virtual property which will include more views, or different views, of the property than shown in the basic tour.

In some embodiments, the virtual tour system may include a learning module, which may be implemented with machine learning, inference modules and other components that can learn about viewer behavior and demographics based on a group of viewers and potential viewers (such as potential buyers of real estate properties) to develop models of viewers and properties. These models can be used to improve the selection of real estate properties to show to particular viewers, the selection of virtual tours for particular viewers and virtual staging of properties during virtual tours. In various embodiments, these components may operate at the virtual tour server, in a virtual tour application or both.

The device data storage 114 can include RAM, ROM, one or more hard drives, one or more flash drives, or some other suitable data storage elements such as disk drives, etc. The device data storage 114 can, in some embodiments, may store the virtual tour as a virtual tour application. In some embodiments, the device data storage 114 can store the data related to the user.

The device communication interface 116 may be any interface that enables the user device 110 to communicate with other computing devices and systems. In some embodiments, the device communication interface 116 can include at least one of a serial port, a parallel port or a USB port. The device communication interface 116 may also include at least one of an Internet, Local Area Network (LAN), Ethernet, Firewire, Bluetooth, modem or digital subscriber line connection. The device communication interface 116 can also include input devices, such as a mouse, a keyboard. a touch screen, a thumbwheel, a track-pad, a track-ball, voice recognition software and the like, depending on the requirements and implementation of the user device 110. For example, the device communication interface 116 can include a display on which information, such as the virtual tour of a real estate property can be shown to the user. The device communication interface 116 can also receive interaction requests for interacting with the virtual tour of the real estate property. In some embodiments, the virtual tour server 120 can be initiated from a connection request received via the network 140 and initiated via an Internet browser application or a virtual tour application or other software executing on the user device 110.

In some embodiments, a user may use multiple user devices (or a user device with multiple output or input components) to interact with and experience a virtual tour. For example, the user may provide text, audio or other inputs through an input device such as a handheld device, and the virtual tour may be shown to the user at one or more other devices such as a desktop computer screens, a virtual reality headset or another output device. In some embodiments, the user devices may be coupled together and software executing on the respective devices may coordinate to receive user inputs and to cohesively deliver the virtual tour.

A virtual tour may be presented to a viewer by a virtual tour guide. The virtual tour guide may be a virtual real estate agent and may be presented in visual, audio or text form, or any combination of those forms. The virtual tour guide may narrate the virtual tour throughout the real estate property for the potential buyer. A visual form of a virtual tour guide may, for example, be a life-like depiction of a person, an avatar of a person, a digitally created image of a person or an icon indicating the position of the tour guide in a virtual tour.

The virtual tour system may use demographic and other information about a viewer, such as a potential buyer of a real estate property, and may include interactions with the potential buyer, to better understand the preferences of the buyer to help select properties to show to the viewer, and to help select or navigate a virtual tour through a property. The virtual real estate agent may optionally develop a profile of the potential buyer based on demographic and other information about the buyer and by asking questions about the potential buyer and what they are looking for in a property. The questions and answers can be received by audio or text. When asking questions using audio, the voice of the human real estate agent may be synthesized, for example using an artificial intelligence audio generation tool. A virtual tour may also incorporate interaction inputs with the virtual tour from the buyer as part of the buyer's profile. For example, if a viewer indicates interest in a particular aspect, location or part of a real estate property during a virtual tour, the virtual tour may be modified to provide additional information to the viewer. For example, a viewer may be able to modify the view of an omnidirectional image during a virtual tour to see a particular item in a room, such as the stove in a kitchen, or a television in a recreation room. By interacting with the virtual tour in this manner, the viewer has indicated an interest in a particular aspect of the property and the virtual tour guide may provide additional information to the viewer based on the interaction input.

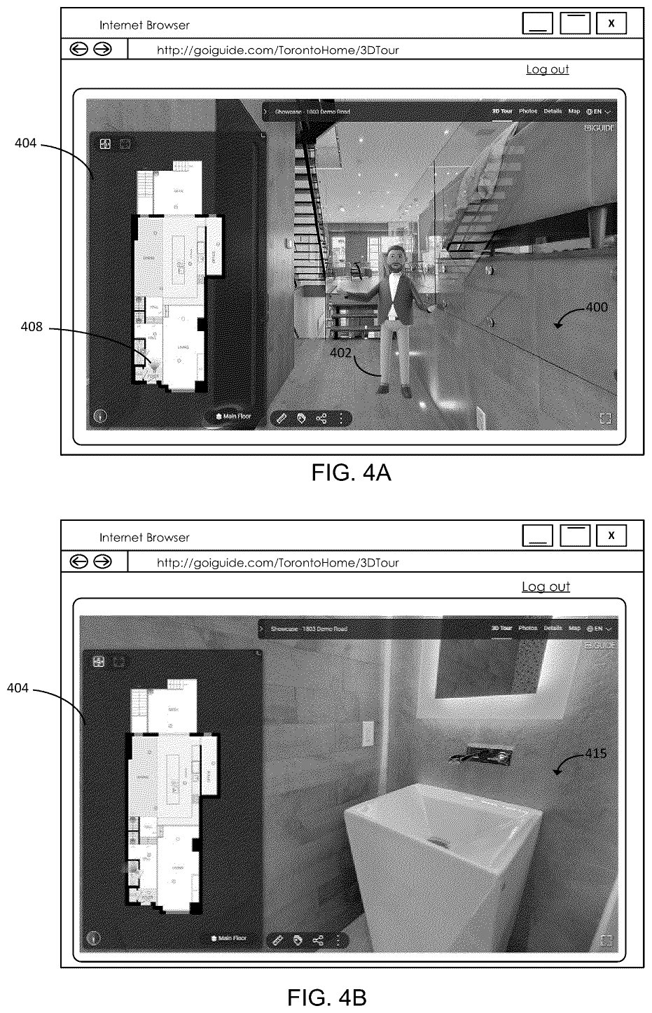

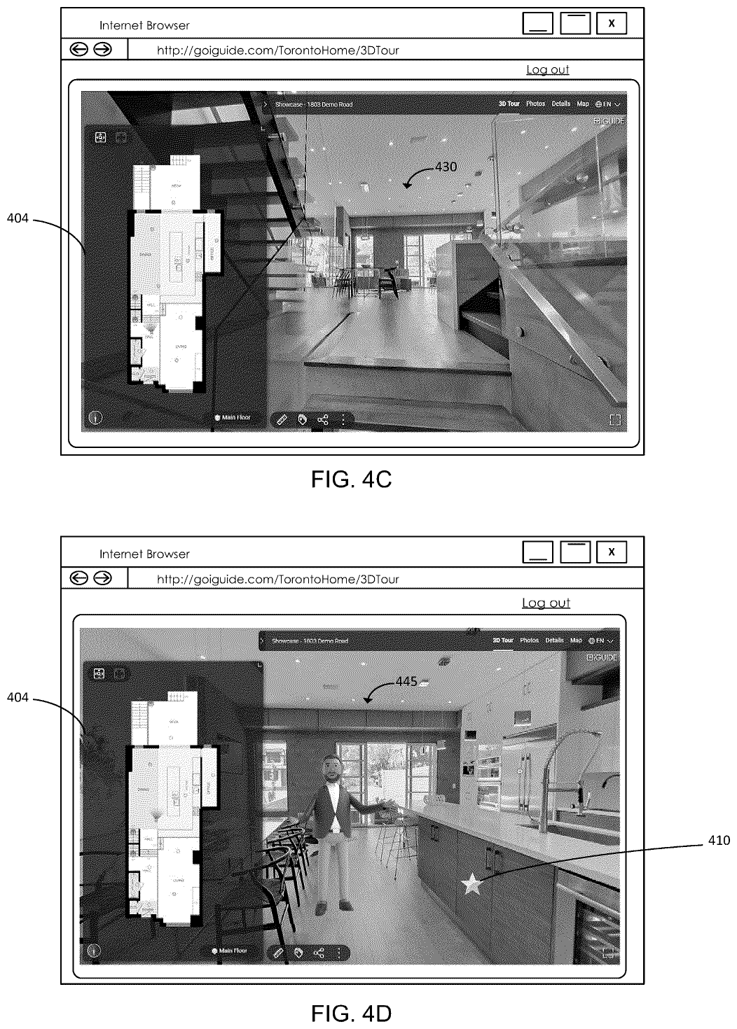

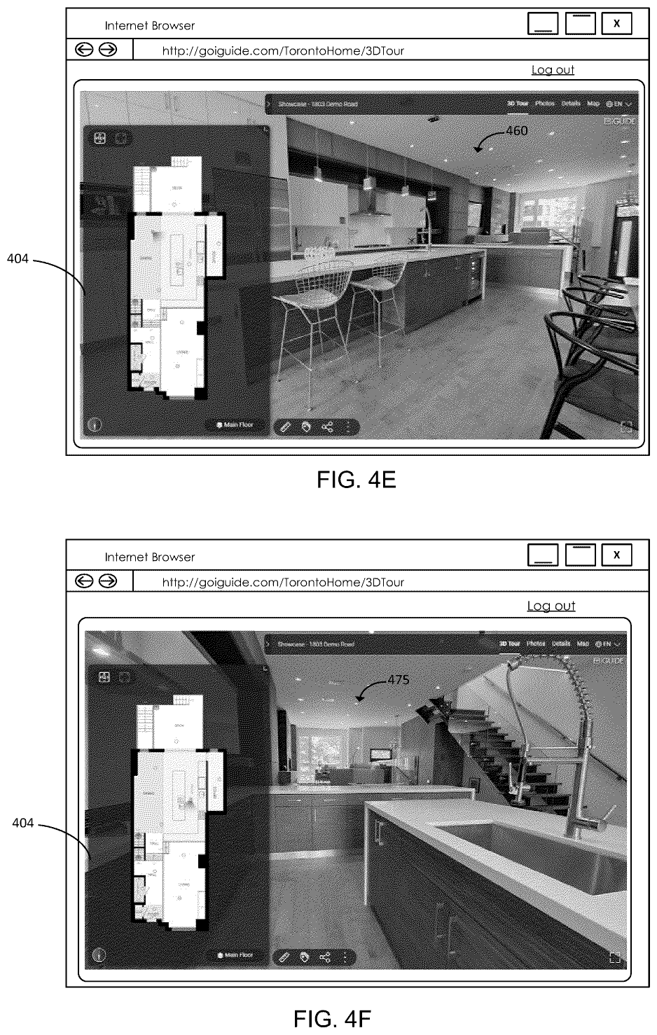

FIG. 2A is a screenshot 200 of an example user interface 202 on an internet browser application 204 from which a virtual tour can be initiated. The user interface 202 shows a collection of omnidirectional images 206 of a real estate property. FIG. 2B is a screenshot 250 of an example user interface 252 on an internet browser application 254. The user interface 252 shows a floorplan 256 of the same real estate property that corresponds to the omnidirectional images 206 of FIG. 2A. The floorplan 206 can be viewed on its own, as shown in FIG. 2B or it may be shown alongside one or more of the omnidirectional images of the real estate property, as shown in FIGS. 4A-4F.

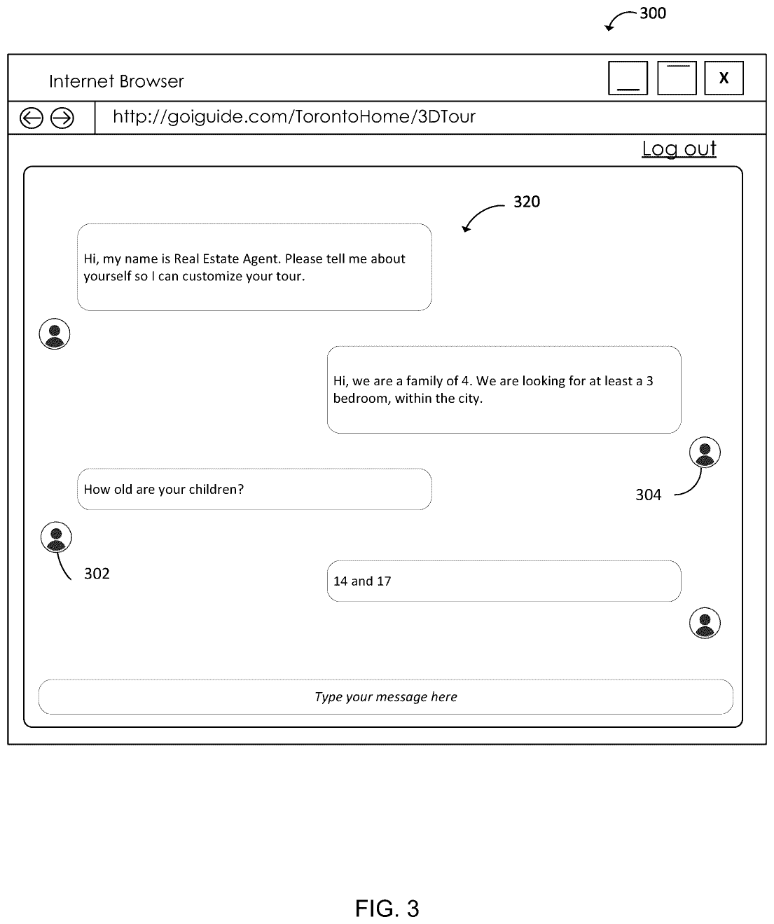

FIG. 3 shows an example of a message exchange 300 between an exemplary virtual real estate agent 302 and a potential buyer 304. The virtual real estate agent 302 may get to know the potential buyer 304 through series of questions and answers, conducted via a message exchange 300 or through a questionnaire (not shown). The interaction may be via text, as illustrated in FIG. 3 or audio based, where questions can be asked audibly to the potential buyer and the system receives a return voice answer from the potential buyer. Alternatively, if the potential buyer and the human real estate agent have met in person or interacted in a different manner, the real estate agent may manually input the buyer's preferences into the system to be stored in the potential buyer's profile. Demographic information of a potential buyer may be retrieved and stored in the potential buyer's profile to be used in developing preferences of the potential buyer. The potential buyer's preferences, and the system's learnings, may be used to provide a more conversational and interactive experience to improve the virtual tour of the real estate property.

As shown in FIG. 3 the virtual real estate agent may prompt the potential buyer with questions 320 to learn about the potential buyer's preferences. In addition, the system can learn potential buyer preferences from either the real estate agent inputting the preferences, the potential buyer inputting their preferences, the potential buyer connecting to their social media account, or learned through the types of properties they choose to view and how they interact with the virtual real estate properties, for example.

The virtual tour system can store the potential buyer's information to be used later when providing a personalized virtual tour of the property or for example, to schedule a physical viewing of the property, or to suggest other properties to virtually tour.

FIGS. 4A, 4B, 4C, 4D, 4E and 4F illustrate an example of a standard virtual tour given by a virtual real estate agent 402. The virtual real estate agent 402 may be a visual representation of a generic real estate agent or may be a visual representation of a real-life real estate agent, such as the human listing agent of the property being toured virtually. The virtual real estate agent may present a virtual tour of the property and narrate the tour in a manner like a real-life tour conducted by a human real estate agent when showing the real estate property. For example, narrations or voice overs might include details of the property currently being toured and/or information about the neighborhood in which the property is located. The virtual tour may include the floorplan of the property 404 in addition to the omnidirectional image. The floorplan 404 can be marked to correspond to the view of the omnidirectional image currently being shown to the potential buyer. For example, in FIG. 4A the potential buyer is viewing the foyer 400 of a real estate property and the marker 408 on the floorplan 404 corresponds to the foyer 400. The marker 408 on the floorplan 404, for example, can be illustrated as with field of view so the potential buyer can see the direction in which they are looking relative to the view of the omnidirectional image.

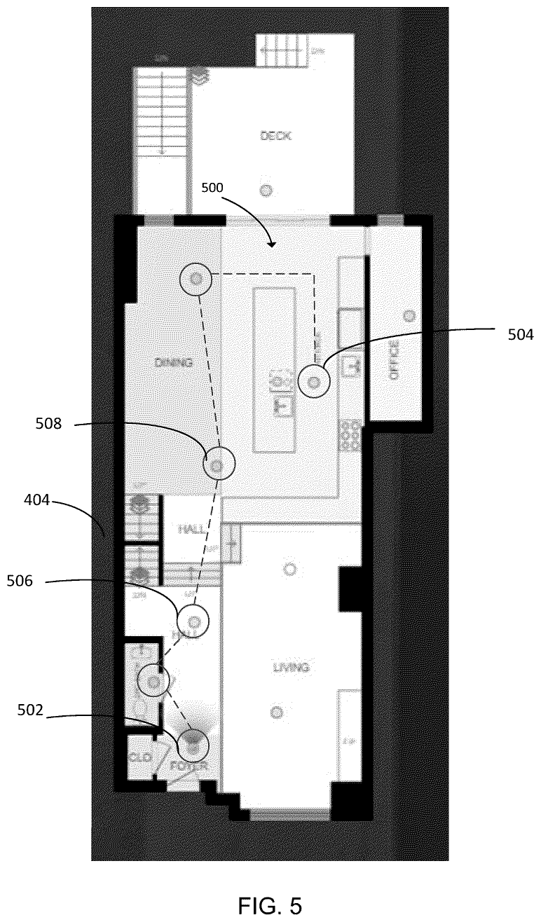

FIG. 5 is a larger view of the floorplan 404 with a standard tour route 500, for a virtual tour, shown with a dashed line. The standard tour route starts at a start point 502 in the foyer and ends at an end point 504 in the kitchen. The standard route 500 may go in sequence of rooms as they appear on the floorplan 404. The standard route 500 is for illustrative purposes and one can appreciate that the tour may visit more rooms and on different levels.

The route 500 of FIG. 5 corresponds to the omnidirectional image views shown in FIGS. 4A, 4B, 4C, 4D, 4E and 4F. As shown in FIG. 4A, the virtual real estate agent 402, greets the viewer in the foyer 400 of the virtual real estate property. Again, although this example provides for a visual representation of the virtual real estate agent 402, in some embodiments there may not be a virtual real estate agent on the virtual view. In which case the virtual tour is only audibly narrated by the virtual real estate agent. The marker 408 on the floorplan 404 shows the viewer that they are standing at the front of the property.

Next, as shown FIG. 4B, the virtual real estate agent takes the viewer (i.e., the potential buyer) to the bathroom 415. The bathroom 415 corresponds to the next room in the real estate property, after the foyer 400, on the standard tour as shown in FIG. 5. Additionally, at each room, and during the transitions between rooms, the virtual real estate agent may provide information related to the property. The system may be selecting which information to share with the potential buyer based on the potential buyer's profile. As described earlier, the profile and preferences may be determined by asking questions during the tour, before the tour, or learned through the potential buyer's interactions with the property or other properties, for example.

In some embodiments, when a virtual tour moves from one location in the virtual real estate property to another, if there is sufficient overlap between the respective images of the two locations, a 6DoF transformation between the images may be calculated and displayed to simulate movement between the locations. In some embodiments, the 6DoF transformation may be progressively calculated such that it includes an image proximal to the first location (i.e., relatively close to the image of the first location), and then progressing through a series of images progressively proximal to the image of the second location. The series of images may be displayed sequentially to simulate progressive movement between the locations. In some embodiments, sufficient images between the first and second locations may be calculated that they may be displayed as a video that smoothly depicts movement between the locations. Such transformations and images may be more accurately and effectively calculated if the images of the first and second locations have sufficient overlap. In some embodiments, a series of images may be created at intermediate locations between a first location and a second location that are included in a tour of a real estate property. These intermediate images may be used to calculate a more accurate series of images used to depict movement between the first and second locations.

Next, in FIGS. 4C and 4D the virtual tour continues in the predetermined standard order as indicated by the standard route 500 in FIG. 5. Following the bathroom, the viewer is taken to the hall 430 and then to the landing area 445. FIGS. 4E and 4F, in accordance with the standard route 500, represent the next rooms on the tour and the virtual real estate agent takes the viewer to the dining room 460 and then to the kitchen 475. Again, at each room, and during the transitions between rooms, the virtual real estate agent may be narrating the virtual tour and may provide personalized information about the property as it relates to the potential buyer and their preferences and/or demographics.

The standard tour, as illustrated in FIG. 5, ends at the end point 504. One of ordinary skill in the art would appreciate that the standard route may be longer, or shorter, than what is illustrated in FIG. 5. The standard route may include more rooms and cover multiple floors of a real estate property and continue until all the rooms, and floors, of the real estate property have been visited, until the system decides to end the tour or until the potential buyer ends the tour, for example.

Additionally, there may be a plurality of predetermined standard routes that the virtual tour system can select from to give the virtual tour to a viewer, such as a potential buyer. The predetermined standard tour routes may be established by the human real estate agent for a given property. The virtual tour system may select one of the routes based on the potential buyer's profile and their preferences.

For example, the human real estate agent may develop a route where the virtual tour begins in the backyard to showcase lots of green space and a pool. The human real estate agent might also develop a different virtual tour route for the same property, but the tour may begin in the basement where there is a games room and a bar. If a young family is interested in viewing the property, the system may select the route that begins in the backyard because the system has determined that this young family, or most young families, desire a property with a pool. Alternatively, if the property is being shown to a professional young couple with no children, the system might select the route that begins with the basement to show the bar and games room since the system has determined that entertaining is an important factor for this potential buyer.

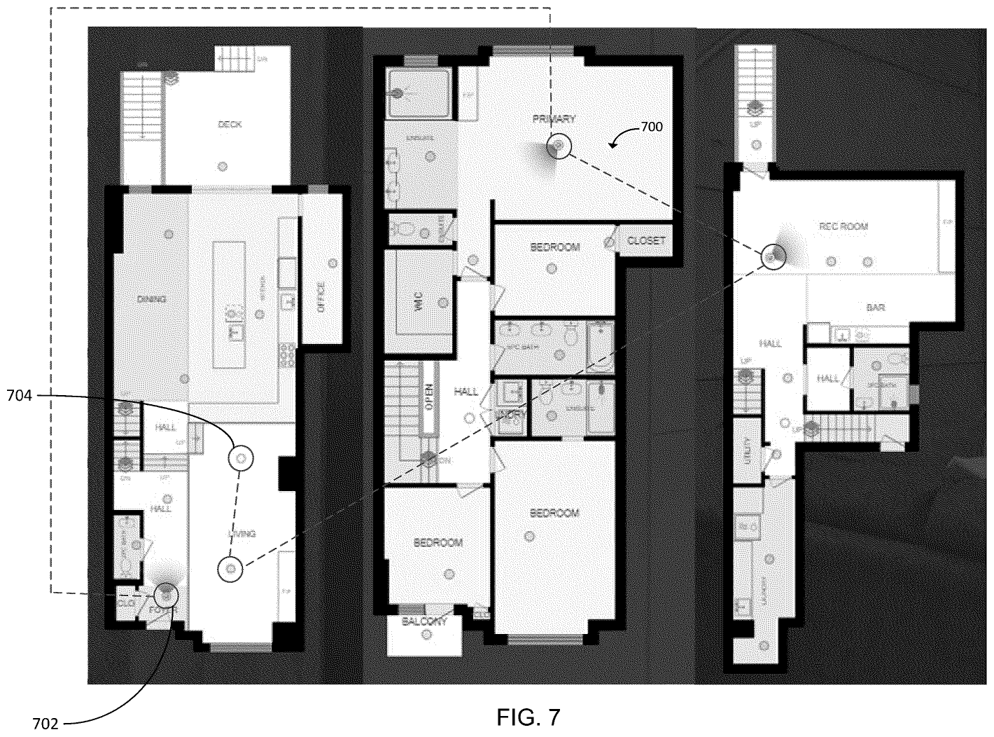

Alternatively, the virtual real estate agent may take the viewer on a tour route that is fully dynamic where the route is being determined and generated by the virtual tour system with little to no influence from a human real estate agent, for example. The dynamic tour route can be generated, and tailored, using the preferences and demographic profile of the potential buyer who will be viewing the virtual tour. For example, such a dynamic route through a property may begin with rooms that are of highest interest to a particular buyer and then move to rooms of lower interest. As another example, a dynamic tour may begin in a foyer and then proceed in the shortest route possible to the room of highest interest to a buyer, thereby preserving a relatively natural depiction of entering and walking through a property but still prioritizing aspects of the real estate property of interest to the buyer. The dynamic tour may also respond to interaction requests the system receives from the viewer. For example, if the viewer changes the view of the omnidirectional image or zooms in on a feature. A dynamic route is illustrated in FIG. 7 and will be discussed in more detail below.

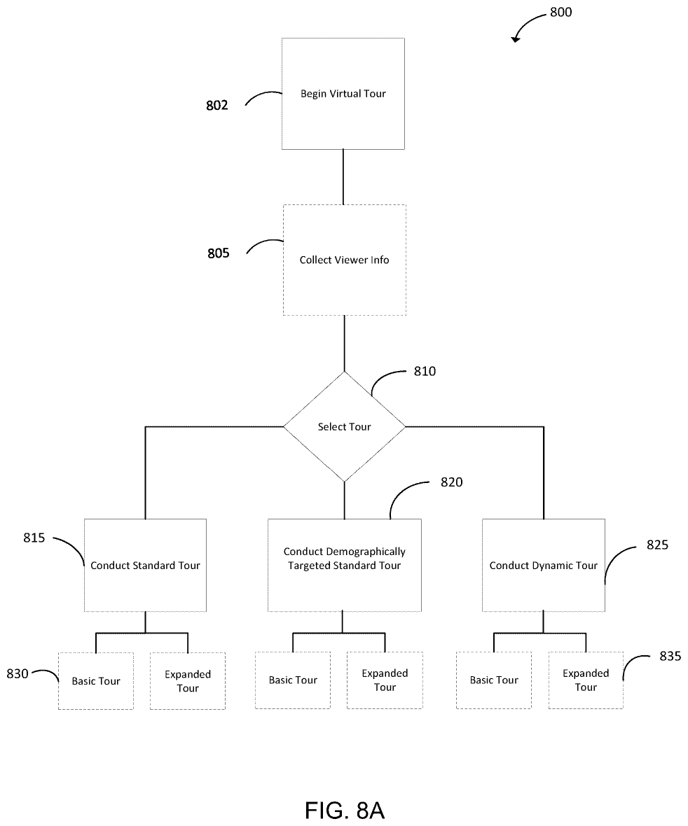

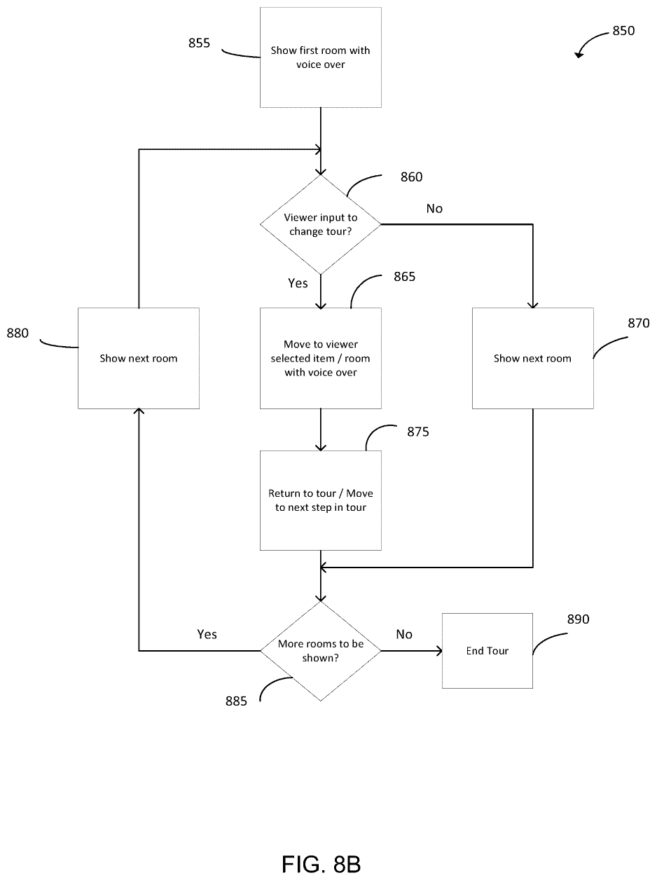

FIG. 8A is a flowchart 800 illustrating different tour route options for the virtual tour system to select from. The virtual tour system begins at step 802. Depending on the viewer who is starting the system, the system will optionally collect the information 805 on the viewer. The information of the viewer may include who their human real estate agent is and the type of virtual tour service the human real estate agent pays for. For example, a human real estate agent might only pay for standard tour route services, which would limit the options of tour routes the system may select from to provide the viewer with. If a standard tour route is the only option available, viewer information may not be required by the system to provide the tour. If viewer information is available, based on the received viewer information, the virtual tour system will select a tour 810. The tour may be a standard tour 815, a demographically targeted tour 820, or a dynamic tour 825. If the system does not have information related to the viewer, or the information is insufficient to select a demographically selected tour or a dynamic tour, or if only a standard tour is available for a real estate property, the standard tour 815 may be selected. For example, a real estate agent may choose to make only a standard tour available for some properties.

The demographically targeted tours 820 may be one or more virtual tour routes for a virtual real estate property developed by the human real estate agent, as discussed earlier. For a given real estate property the real estate agent may develop different routes to give to different viewer profiles based on their demographics and other viewer information. For example, a tour given to a large family may be different than a tour given to a retired couple with no children. If the system selects a tour 810 that is a demographically targeted tour 820 the system may have selected a tour among at least one demographically targeted tours as curated by the real estate agent, for example.

Even though a route might be selected from a plurality of pre-determined routes, as in the standard tour 815 and the demographically targeted tour 820, the system remains interactive for the viewer, and the viewer may interact with the omnidirectional images of the real estate property, and the system will adjust and respond accordingly. For example, referring to the route 500 of FIG. 5, if the system was at a point in the tour where the virtual real estate agent was in the hall 506, and the potential buyer asked a question about the primary bedroom, the system may move the tour to the second floor and show the primary bedroom in response to the potential buyer's question about the primary bedroom. After the primary bedroom is shown the system may resume the rest of the standard tour or may continue from the current location in the tour. For example, referring to the route 500 in FIG. 5 if the system resumed the predetermined route 500, the viewer would be brought back to the main floor and continue the tour by going to the next room which corresponds to the dining and kitchen area 508. Alternatively, since the viewer was brought to the second floor in response to their interaction, the system may choose to tour the entirety of the second floor before resuming the route on the main floor. In a further embodiment, in response to the viewer's question about the primary bedroom, the system may transition more smoothly to the second floor. For example, the system may show and discuss the stairs and second floor landing before showing the viewer the primary bedroom.

Referring to FIG. 8B a flowchart 850 is shown to illustrate how the system responds to a viewer, such as a potential buyer, inputting a change to the tour as discussed above. The virtual tour routes disclosed herein may begin with the system showing a first room 855. If the virtual tour system receives an input from the viewer 860 to change the view, or ask a question, the system will respond accordingly. If such an input is received, the tour will move to the room or item related to the viewer's question 865. For example, if the viewer asked a question about a different room, the system may respond by showing that room even if the room of interest was not the next room planned for the virtual tour. The narrations provided by the virtual tour system may also adjust accordingly. If the viewer moves the view in the kitchen, for example, from the stove to the fridge, the system may then discuss the fridge even if that was not the next talking point for the virtual real estate agent. After discussing the room or item related to the received viewer input 860, the system returns to the respective tour route 875. If there had been no viewer input 860 received by the system, the tour will continue to the next room 870. If all the rooms of the property have been shown 885 the system will end the tour 890. If there are more rooms to be shown on the tour, the system will continue with the tour and show the viewer the next room 880.

In some embodiments, the data for a real estate property recorded in the virtual tour server may include specific details about the property, locations in the property or items in the property. For example, factual information such as the address of the property, square footage of the property or parts of the property, details of items in the property, finishes on surfaces, appliances, countertops, the age of the property or improvements to the property, information about the neighborhood in which the property is located, accessibility to transit, schools and parks, and other information may be recorded by the real estate agent when adding a property to the virtual tour system. A real estate agent (or other user of system 100) may be able to provide such information when configuring the data for a real estate property. For example, the real estate agent may be able to display images of a real estate property and provide such information either by selecting items on an image and recording the information. In some embodiments, the user may be able to type in the information or provide the information verbally for recording. For example, the user may click on the floor in a room and say “Hardwood maple flooring with a cognac stain. Professionally installed in 2021.” This information may be recorded as audio, or converted to text and recorded in text form, or both. Optionally, the information may be parsed and recorded in a format suitable for subsequent text-to-speech presentation by a virtual tour guide during a virtual tour.

During a virtual tour, a viewer may be able to ask questions about the property, items and locations within the property either through a text or audio interface and the virtual tour application can provide answers to inform the viewer about the property. For example, the user may be able to ask about the dimensions of a room and the virtual tour guide may respond by providing the requested information. In some embodiments, the virtual tour application may also monitor the viewer's interaction inputs, such as the user modifying the display of an image to show a particular item or the user looking at a particular portion of an image (through the use of an eye tracking system coupled to a user device), and provide information about the item in which the user has expressed interest. For example, a viewer may move the display of an image to show a refrigerator. The virtual tour guide may respond by providing information about the brand, features and age of the refrigerator. A viewer may ask (be typing or verbally) about the countertops in a kitchen and the virtual tour guide may respond by providing information about the material and color of the countertops.

If the virtual tour system selects a dynamic tour 825, the system will generate the tour route based on the received viewer information which may include their preferences. Alternatively, if no viewer information is received, the dynamic tour 825 may begin as a standard tour route and then dynamically adapt as the viewer interacts with the virtual tour. FIG. 7 illustrates a dynamic tour route 700 for a real estate property. The starting point 702 of the dynamic tour route 700 begins in the foyer and the example dynamic tour ends at the end point 704 of the dynamic tour route 700. The dynamic tour route 700 is for illustrative purposes. A dynamic route may include all the rooms in a given property, or the dynamic tour may end when the system determines an end, when the viewer ends the tour, or the virtual tour system may decide to revisit a room. FIG. 7 is an example dynamic tour route and is not meant to be limiting but is used to illustrate the dynamic routes the virtual tour system may generate.

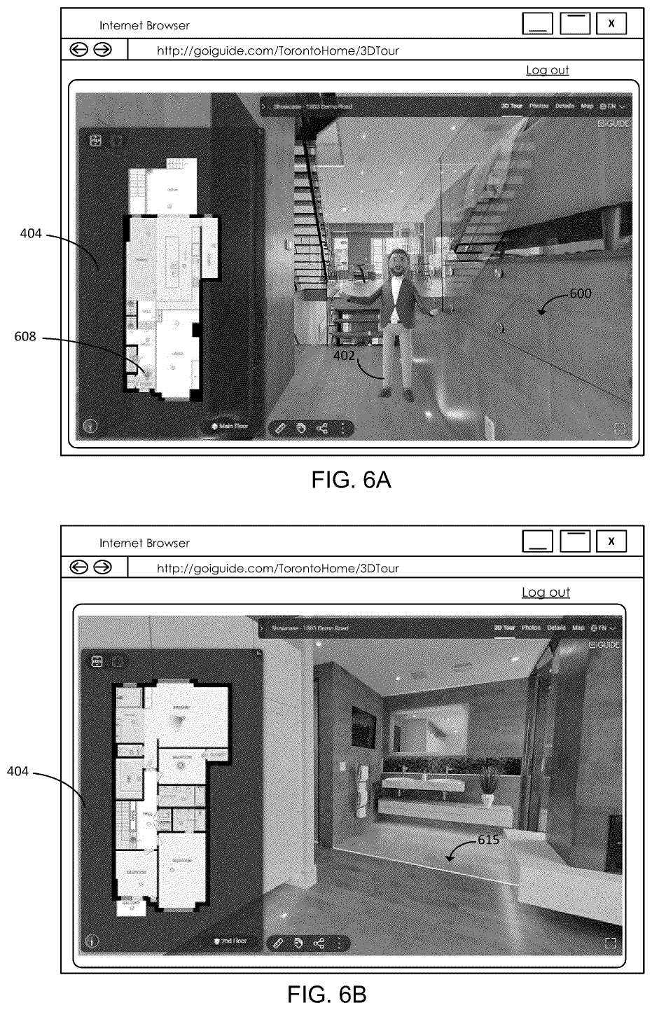

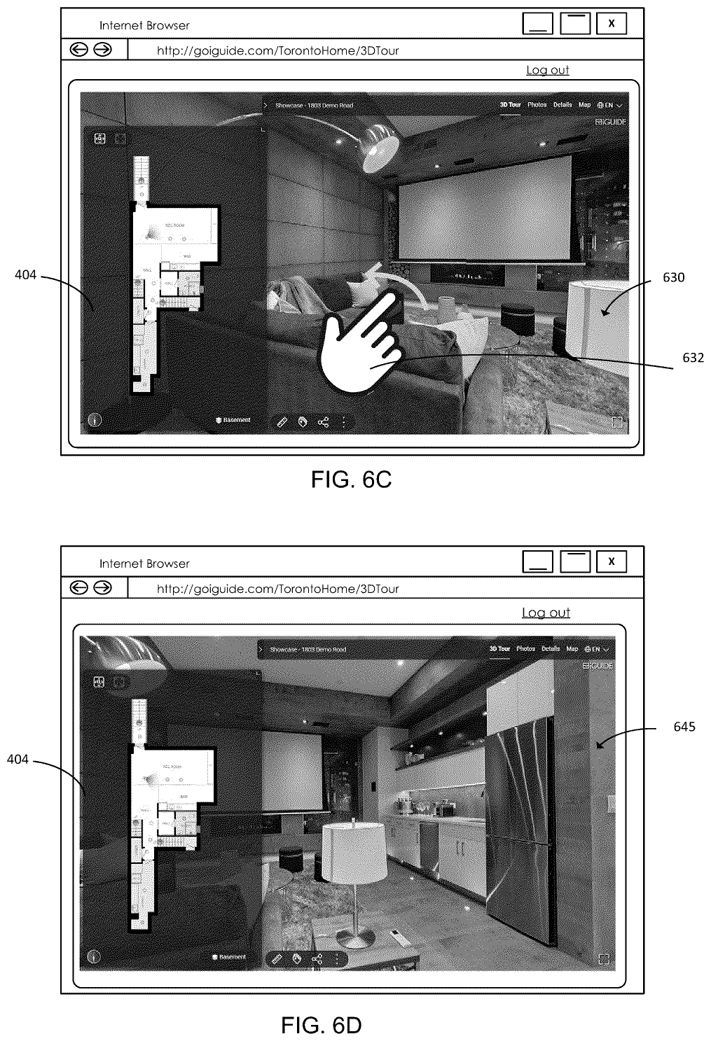

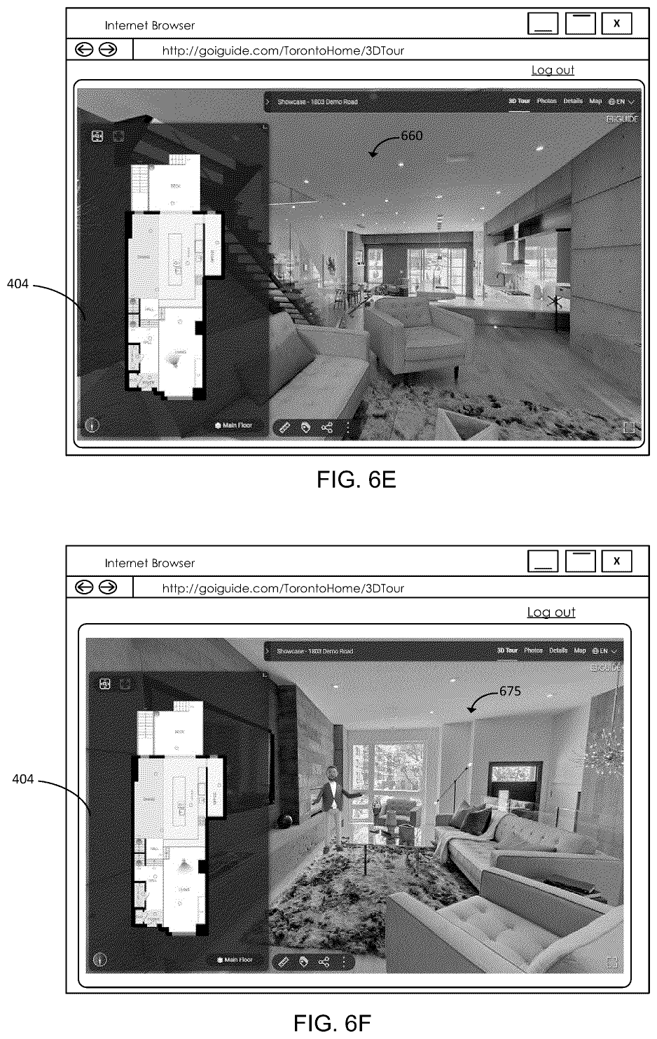

FIGS. 6A, 6B, 6C, 6D, 6E and 6F illustrate an example of a virtual tour given by a virtual real estate agent 402. The virtual real estate agent 402 may be a visual representation of a generic real estate agent or may be a visual representation of a real-life real estate agent. The virtual real estate agent may present a virtual tour of the virtual property and narrate the tour in a manner like a real-life tour conducted by a human real estate agent when showing the real estate property. For example, narrations might include details of the property currently being toured and/or information about the neighborhood in which the property is located. The virtual tour may include the floorplan of the property 404 in addition to the omnidirectional image. The floorplan 404 may be marked to correspond to the view of the omnidirectional image currently being shown to the potential buyer. For example, in FIG. 6A the potential buyer is viewing the foyer 600 of a real estate property and the marker 608 on the floorplan 404 corresponds to the foyer 600. The marker 608 on the floorplan 404, for example, can be illustrated as with field of view so the potential buyer can see the direction in which they are looking relative to the view of the omnidirectional image.

FIG. 7 is a larger view of the floorplan 404 with an example dynamic tour route 700, for a virtual tour, shown with a dashed line. The virtual real estate agent 402 on FIG. 6A shows the property to the potential buyer in a sequence that relates to the potential buyer's preferences and profile information. For example, after the virtual real estate agent greets the potential buyer in the foyer 600, the view changes and the potential buyer is brought to the second floor of the property to show the primary bedroom and primary bathroom 615. This may be because the potential buyer directly expressed the importance of the primary bedroom, or because the virtual real estate agent has shown the potential buyer several properties before, and the virtual tour system has learned that the potential buyer is interested in the primary bedroom. Therefore, the virtual real estate agent takes the potential buyer to the most important part of the property in accordance with the potential buyer preferences. Unlike the example standard tour in FIGS. 4A-4F where the tour route may occur sequentially through a predetermined order of rooms, or in accordance with a set route, the order of rooms in the dynamic tour route may be based on the potential buyer's preferences and the interactions with the virtual property.

After showing the potential buyer the primary bedroom 615, the next most important thing for the potential buyer may be the ability to host and entertain. As such, the virtual real estate agent will take the potential buyer to the basement where an entertainment space 630 is located as depicted in FIG. 6C.

The virtual tour system provides for further interactions with the potential buyer by allowing the potential buyer to adjust the view of the omnidirectional image for the room they are currently viewing or to move to another room. The system is also interactive and can receive and respond to interaction requests initiated by the viewer. For example, as shown in FIG. 6C the potential buyer may be interested in the bar section of the entertainment area 630, so the potential buyer adjusts the view of the omnidirectional image of the entertainment area 630, as indicated by the hand motion 632, to the left to switch the view toward the right where the bar is located. As previously discussed, the virtual real estate agent may be narrating the virtual tour by providing details of the property and details about what is in view for the viewer. For example, if the potential buyer switches the view, as indicated by the hand motion 632, the view will change from FIG. 6C, which shows the entertainment area 630, to changing the view to FIG. 6D, which shows the bar area 645. Since the virtual real estate agent may be narrating the tour, the narrations may be explaining something related to the entertainment area 630 while the potential buyer is switching the field of view. The virtual real estate agent may choose to smoothly transition to discussing the bar 645 or put a hard stop on discussing the entertainment area 630. A smooth transition may have the virtual real estate agent finishing narrating the entertainment area 630 and/or intelligently linking in a talking point about the bar 630 since the potential buyer has signaled that is what they are interested in. A hard stop may have the virtual real estate agent not finishing their talking point about the entertainment area 630 and transitioning immediately to discussing what the potential buyer has changed the view to. Although this interaction example is shown for a dynamic tour, this functionality can occur with a standard tour or a demographically targeted tour, or any other type of tour the virtual system may provide.

As shown in FIG. 6E and in accordance with the dynamic route 700 of FIG. 7, the next room on the tour shown to the potential buyer, after the bar area 645, is the main living room space 660. Again, the order of room showings on the virtual tour route is linked to the preferences of the viewer (i.e., potential buyer) as determined by the virtual tour system. The view changes again in FIG. 6F to show a different angle of the main living room area 675. Although the dynamic route 700 ends in the living room 675, one of ordinary skill in the art would appreciate that the dynamic route may, for example, continue until all the rooms have been visited, until the potential buyer has no further questions, until the system ends the tour, until the potential buyer ends the tour, or the system may decide to revisit a room.

In some embodiments, the various virtual tours available for a property may include different levels of information. For example, one virtual tour may be a basic or teaser tour providing a limited tour of a property. Another virtual tour may provide a more detailed or comprehensive tour of the property. In various embodiments, several virtual tours may be defined that include different levels of detail or information, or different specific elements of information. For example, a basic tour may include images (which may be any type of image including omnidirectional images) of only the primary areas of a property, such as the entry, living room, kitchen and bedrooms. A more detailed or expanded or intermediate tour for the same property may also include images of additional areas such as bathrooms, a front yard or a back yard. An even more detailed or even more expanded or comprehensive tour of the same property may additionally include image of storage areas, basements and sheds. In some embodiments, a more detailed tour may not include images that are included in a less detailed tour. For example, a less detailed tour may include a wide image of a basement showing little detail. A more detailed tour of the same property may not include that wide image, but include several other images of the basement showing different parts of the basement in greater detail. Each of the different virtual tours of varying levels of detail may have one or more tour routes, as described above in relation to tour routes 815, 820 and 825. This allows a virtual tour with a selected level of detail to be presented with various tour routes. Similarly, each of the tour routes may be presented based on any of the different virtual tours, with elements that are not included in a particular virtual tours skipped in the tour route. This allows a tour route to be defined for use with one or more of different virtual tours for a property.

A potential buyer or viewer may be given access to different virtual tours of varying levels of details based on various factors. For example, a viewer that has not created an account in the system may be given access to only a basic tour. A viewer with an account may be given access to a more detailed tour. In various embodiments other factors, such as the viewer providing personal information (including contact information, providing demographic information such as income, current address, family status and other information may be of interest to a human real estate agent), the viewer paying a membership or subscription fee, the viewer have a selected status (such as being a registered real estate agent), the viewer agreeing to provide feedback on the system or on properties, may be used to determine the particular virtual tour that is presented to the viewer.

Referring to FIG. 8A, each of the different tour routes 815, 820, and 825, may be presented using a basic tour 830 (with a relatively lower level of information or detail), or an expanded tour 835 (with a relatively higher level of information or detail). The expanded tour may be presented if the viewer has access to it by complying with one or more factors. The basic tour may restrict the viewer's perspectives of the property, while the expanded tour may offer a broader or alternative array of views of the property. For example, in a basic tour for a property, the viewer may be limited to the main areas of the property such as the living space, kitchen, and primary bedroom, and may not be able to view secondary areas such as a guest bedroom closet, a kitchen pantry, or utility room. In the expanded tour, the viewer may be able to tour more areas of the property such as a garage, storage room, or different views of the areas they may have seen in the basic tour, such as the inside of a closet in the primary bedroom. For each of the basic tour and expanded tour of the property, there may be a plurality of tour routes. For example, in one tour route for a basic tour of the property, the viewer may see all the main rooms. In another tour route for the same basic tour of the property, the viewer may see all main rooms and a section of the backyard, for example.

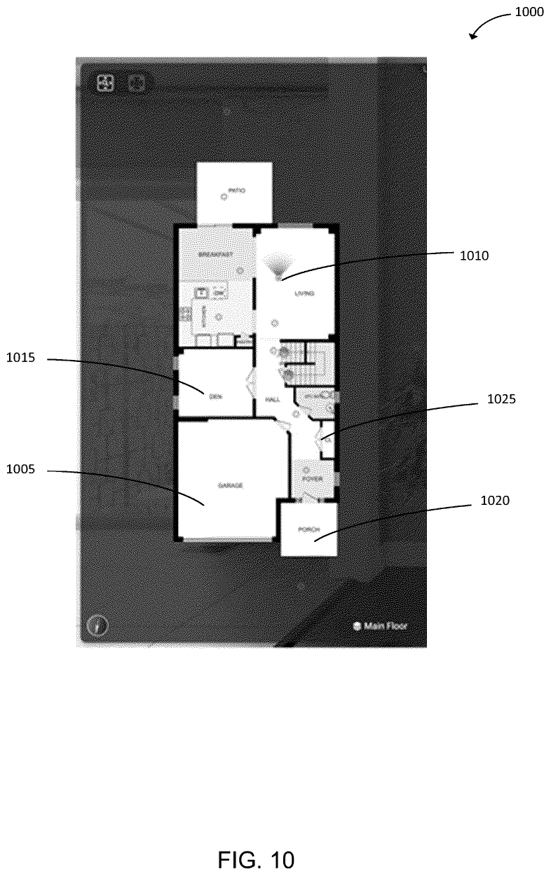

FIG. 10 illustrates an example of the areas of a property available to tour in a basic tour 1000 for a viewer. For example, the markers 1010 illustrate the areas of the property the viewer can access in basic tour. In the example, the garage 1005, den 1015, porch 1020, and closet 1025 do not have markers and are therefore inaccessible for viewing in the basic tour. In the expanded tour of the property, the viewer may gain access to viewing the garage 1005, den 1015, porch 1020, and closet 1025. The additional areas available for viewing in the extended view may be indicated with markers like 1010. The areas of the property inaccessible in basic tour may be indicated on the floorplan by indicating in another color on the floorplan, for example.

The expanded tour may include the ability to alternate between different views of the same location of the property. The basic tour may limit the viewer to areas of the property to more presentable spaces, such as a living room, and may be unable to view less presentable spaces, such as a storage closet, an unfinished basement or a garage. The expanded tour may allow for the viewer to alternate between different views to gain more information about the property they are viewing. For example, in FIG. 4D the viewer may select a button 410 to trigger an alternative view of the kitchen cabinet. If the viewer triggers the button 410 the kitchen cabinet door may be shown in an open position (not pictured), if selected again, the kitchen cabinet may be shown in a further alternate position (for example with different items in the cabinet) or return to the original view. The alternate views available to a viewer in an expanded tour may be triggered by a button, hovering over the area with a mouse, or by voice command, for example. Additionally, the viewer may be prompted to switch views by the virtual guide alerting the viewer to the switching functionality by messaging in a chat, or through an audio command, for example. Switching between alternate views in the expanded tour may also be automatic and the viewer may not have to manually interact with the tour to view the alternate views. In various embodiments, an expanded tours may be conducted with or without the alternate view functionality. For example, the alternative views may be a supplemental feature that an administrator or a real estate agent user of the virtual tour system chooses to purchase or enable. In a basic tour, all the closets may be in a closed position and in the expanded tour, all the closets may be in an open position. If the alternative view functionality is enabled, the ability to switch between displaying some or all of the closet doors in a closed and open position will be available to the viewer.

In some embodiments, a expanded tour may only be accessible if the viewer has been granted permission. For example, to gain access, a viewer may have to provide contact information, such as email or phone number, and optional comments about the property so the human real estate agent can gain market feedback of the property.

A basic tour may be used to determine if a viewer should be granted access to the expanded tour based on the viewer's interest in the property based on the viewer's interaction with the basic tour. Interest in the property by the viewer may be determined by total interaction time with the basic tour, number of camera positions viewed, number of floors viewed, number of rooms viewed, proportion of the basic tour viewed, how long each room was viewed for, social sharing, for example. If the viewer meets a threshold for some or all of these interaction types, the viewer may be given access to the expanded tour.

For example, a real estate agent associated with a property may choose to allow any viewer to access a standard tour route 815 using a basic tour 830. Once it has been established that the viewer is interested in the property and provides their contact information or sufficiently interacts with the basic tour or meets another threshold or requirement, the viewer may then be granted access to a demographically targeted standard tour 820 using an expanded tour. The different types of tour routes and view options may be dependent on the property, the human real estate agent, and the services the viewer pays for.

In an embodiment where a viewer provides contact information to access an expanded tour, the contact information of the viewer may be passed on to a human real estate agent who may follow up to interact directly with the viewer to collect market feedback about the property before they grant access to an expanded tour of the property. Alternatively, the system may be automated and after receiving the contact information of the viewer, a chat may be launched to engage with the viewer immediately. The chat may be live with the human real estate agent, an autoreply chat, or conducted with a virtual guide. The contact information may further be used to send an autoreply text message or email to connect with the viewer and gain additional feedback on the property.

Instead of submitting the contact information for each property, the viewer may create a user profile containing their contact information associated with the tour system. Depending on the property, a viewer with a user profile may have immediate access to the expanded tour of some or all properties in the system. Alternatively, to gain access to the expanded tour of a property the registered user may have to provide comments on the property, or request access from the human real estate agent or the virtual guide, for example.

In some embodiments, the basic tour and expanded tour may not be associated with a virtual tour route. The basic and expanded tours may be limited to the viewer interacting with the omnidirectional images and without a virtual tour route and virtual guide as described above.

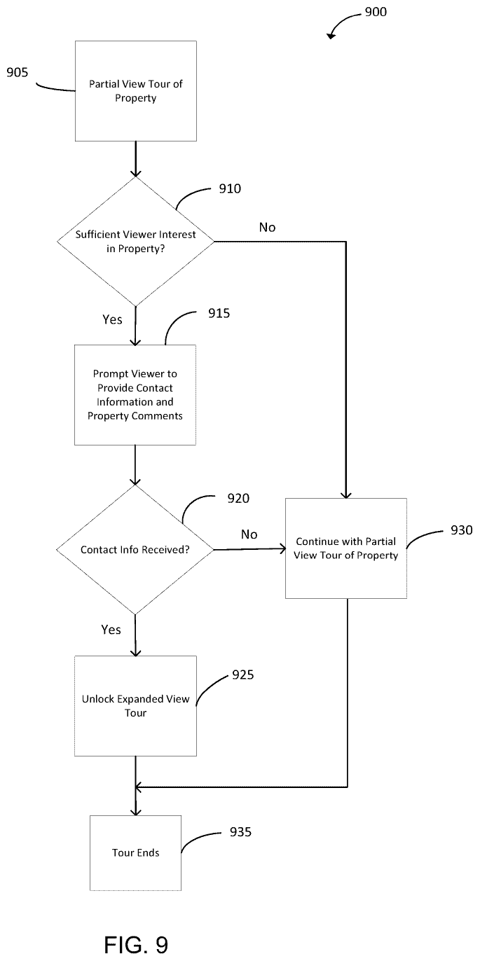

Referring to FIG. 9 a flowchart 900 is shown to illustrate how an expanded tour of the property may be accessed by a viewer. A viewer can virtually tour a basic tour of a property 905. If it is determined that the viewer has shown sufficient interest in the property, they may be prompted to provide their contact information and optional comments on the property 915, if contact information is provided 920, the viewer will eventually be granted access to the expanded tour of the property 925. The viewer may also be deemed to have provided their contact information if they have a user profile associated with the tour system. If no contact information is provided, although sufficient interest in the property was established, the viewer will continue with the basic tour 930. Interest in the property by the viewer may be determined by total interaction time with the basic tour, number of camera positions viewed, number of floors viewed, how many rooms viewed, how far into the basic tour the viewer made it, how long each room was viewed for, social sharing, for example. If there is insufficient viewer interest in the property 910 then the viewer may remain restricted to the basic tour of the property 930.

If the viewer is granted access to the expanded tour of the property, they may be taken on a virtual tour of the property, with or without a virtual guide, as described above, interact with the expanded tour of the property at their leisure, or may be guided through the expanded tour of the property by a human real estate agent. If the viewer is guided through the expanded tour of the property by the human real estate agent, the viewer may not gain direct access to the expanded tour. For example, the viewer may be presented the expanded tour by the human real estate agent who may conduct the virtual tour by sharing their screen with the viewer, or the viewer can be provided with a time restricted access to the expanded tour and the real estate agent may control the tour at the user end.

The embodiments disclosed herein present many benefits for real estate agents, buyers, and seller. The system may allow for a real estate agent to be simultaneously showing the property during an in-person viewing, while the virtual representation of the real estate agent can be showing the same property to multiple viewers through the virtual tour system. Additionally, for the potential buyer they receive the benefit of having a personalized tour hosted by the real estate agent while receiving the same level of personalization as could be expected in a real life viewing of the real estate property. For the potential seller, the property can be toured by many potential buyers all without having to physically open their home.

In some embodiments, the virtual tour guide may not be a physical representation. Or some physical embodiments of the virtual tour guide may not be a human avatar as depicted in the embodiments described above. The virtual tour guide may also only be audio based, or text based with the narrations appearing on screen through a chat box or as pop-up messages on the screen, for example. Some embodiments may be any combination of a physical representation of the virtual tour guide, the audio narrations of the virtual tour guide, or text.

In some embodiments, the omnidirectional images may be formed by stitching together hemispherical images or other partial images of a location for a given property. The stitched images may be overlayed on 3D point cloud or 3D mesh in order to create a 3D survey of the property to be used for conducting the virtual tour of the property.

System 100 can simultaneously delivery many virtual tours to many viewers. A particular real estate property could be shown in a virtual tour to many different viewers at the same time. Some of the viewers may be shown a virtual tour that is selected for them based on their demographics, interests and behaviors, allowing the real estate property to be presented to various potential buyers in a manner that is of interest to those buyers. For example, different viewers of the same real estate property may be shown different virtual tours that focus on different aspects of the real estate property, are presented in different formats, in different languages, by virtual real estate agents that appear differently. For example, different real estate agents attempting to sell the same real estate property may configure virtual tours presented to their clients to be shown by a virtual tour guide that is an avatar of themselves. Each real estate agent's clients will see an avatar of their own agent during their respective virtual tours.

Similarly, a particular real estate agent may list or attempt to sell multiple real estate properties using a virtual tour system. Multiple viewers may view virtual tours for those properties at the same time, allowing the real estate agent to virtually provide multiple virtual tours in avatar form simultaneously.

The virtual tour system allows a viewer to view a virtual tour asynchronously from their real estate agent. They can view a virtual tour at any time, eliminating the need to meet physically at a property with their real estate agent to gain access to the property. A viewer can view the property multiple times through different versions of virtual tours, again without requiring their real estate agent to be present. A viewer can also view many more properties using the virtual tour system than would be possible through physical tours. The viewer can practically view virtual tours for distant properties without travelling physically to the properties, potentially expanding the base of potential buyers for some properties.

A viewer's behavior while viewing virtual tours, including the selection of properties, selection of virtual tours, number of times viewing particular properties (or similar properties), the price range, size, location and other characteristics of properties, as well as other behaviors and interests may be recorded as part of the user's profile in the virtual tour system. This information may be provided to a real estate agent (or other users of the system) to assist the real estate agent in working with the viewer as a potential buyer of real estate.

In some embodiments, a virtual tour may present images of the real estate modified to depict furniture, decorations and other items within the virtual property. For example, a real estate agent may produce a virtual staging of a property or a location within a property to configure a virtual tour of a property to include images overlaid on (or incorporated into) omnidirectional images, videos and other data about the property. The images may depict items in the property to present the property with a design. For example, a room may be displayed with images to make it appear as a study, a family room, a nursery or a hobby room. In some cases, surfaces and other elements in a room may be shown with a color or pattern to illustrate how the room would look with different finishes. For example, a room may be shown with a selected paint color on the walls, a selected flooring. In some embodiments, the real estate agent may configure a variety of appearances for various locations in a property and the viewer may be able to selected amongst the configured appearances when viewing the location. In some embodiments, the configuration of some location in a property may be associated so that they are displayed during a virtual tour so that the property has a consistent appearance. For example, one configuration may provide a virtual tour with virtual staging suitable for a family with young children. Another virtual staging may be suitable for a family that entertains regularly. The various virtual staging configurations may be used in various standard, demographically selected and dynamic tours to provide a virtual tour that is suitable for particular viewers.

In some embodiments, during a virtual tour, the viewer may be able to change the items and finishes depicted in the room by choosing from a library of items and finishes provided in the virtual tour system. This may provide the user with a virtual renovation or virtual decoration functionality that allows the user to view a property with a configuration that is of interest to the user.

Data for items and finishes for virtual staging and virtual decoration may be stored in the virtual tour system on virtual tour server or in applications on user devices or both. For example, a library of items and finishes may be stored on the virtual tour server and may be used to configure various appearances for locations in a property. These configurations may be stored in the data for a real property on the virtual tour server for later delivery and reproduction during a virtual tour displayed on user device. An application running on a user device may be able to download items and finishes from the library stored on the virtual tour server and may be able to display the items and finishes on images to provide the virtual staging and virtual decoration functionality at the user device. In some embodiments, a viewer of a virtual tour may be able to upload an image of an item or finish and use the uploaded image to modify an image within a virtual tour in order to see a location with the item or finish. For example, the viewer tour may upload an image of their own furniture and have it displayed as part of a virtual staging of a location.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto.

1. A computer implemented method for providing a virtual tour of a real estate property to a potential buyer of the real estate property, the method comprising:
assembling, at a virtual tour server, a plurality of images wherein each image corresponds to a location in the property;
transmitting at least some of the images to a user device; and
presenting, at the user device, a virtual tour of the property by displaying at least some of the images of the real estate property, wherein the virtual tour is presented by a virtual tour guide, and wherein the virtual tour guide includes an audio guide component that includes, when one or more of the images are displayed, a narration corresponding to the displayed images.

2. The method of claim 1 wherein the presentation of the virtual tour includes display of a floorplan of the real estate property, and wherein, when one of the images is displayed, the display of the floorplan includes a marker identifying the location corresponding to the displayed image.

3. The method of claim 1 wherein the virtual tour guide is additionally presented with a video guide component.

4. The method of claim 1 wherein the virtual tour guide is additionally presented with a video guide component, and wherein the video guide component includes an avatar of a person.

5. The method of claim 1 wherein the virtual tour guide is additionally presented with a video guide component, and wherein the video guide component includes a digitally created image of a person.

6. The method of claim 1 wherein at least some of the images are displayed in an order corresponding to buyer preference information corresponding to the potential buyer.

7. The method of claim 1 wherein at least some of the buyer preference information is determined based on inputs provided by the potential buyer during the virtual tour.

8. The method of claim 7 wherein at least some of the buyer preference information is determined prior to the presentation of the virtual tour based on demographic information about the potential buyer.

9. The method of claim 7 wherein at least some of the buyer preference information is determined prior to the presentation of the virtual tour based on the potential buyer's interactions with at least one previous virtual tour of a different real estate property.

10. The method of claim 1 wherein at least some of the buyer preference information is determined based on responses provided by the potential buyer in response to prompts from the virtual tour guide during the virtual tour.

11. A computer implemented method for providing a virtual tour of a real estate property, the method comprising:
collecting, at a virtual tour server, buyer preference information corresponding to a potential buyer of the real estate property;
assembling, at a virtual tour server, a plurality of images wherein each image corresponds to a location in the property;
transmitting at least some of the images to a user device; and
presenting, at the user device, a virtual tour of the property by displaying at least some of the images in an order based on the buyer preference information.

12. The method of claim 11 wherein the presentation of the virtual tour includes display of a floorplan of the real estate property, and wherein, when one of the images is displayed, the display of the floorplan includes a marker identifying the location corresponding to the displayed image.

13. The method of claim 11 wherein the virtual tour is presented at the user device by a virtual real estate agent, wherein the virtual real estate agent includes an audio guide component.

14. The method of claim 11 wherein the virtual tour is presented at the user device by a virtual real estate agent, wherein the virtual real estate agent includes an audio guide component and a video guide component.

15. The method of claim 11 wherein the order of the images presented during the virtual tour is modified based on the buyer preference information collected during the presentation of the virtual tour.

16. The method of claim 11 wherein at least some of the buyer preference information is collected during the virtual tour by presenting an interactive user interface including a series of prompts and by receiving a series of corresponding answers, wherein the buyer preference information is extracted from the answers.

17. The method of claim 12 wherein the series of prompts is presented in the interactive user interface by a virtual real estate agent, wherein the virtual real estate agent includes an audio guide component.

18. The method of claim 12 wherein the series of prompts is presented in the interactive user interface by a virtual real estate agent, wherein the virtual real estate agent includes an audio guide component and a video component.

19. The method of claim 12 wherein the series of prompts is presented in the interactive user interface by a virtual real estate agent, wherein the virtual real estate agent includes an text guide component.

20. The method of claim 16 wherein at least some of the buyer preference information is determined prior to the presentation of the virtual tour based on demographic information about the potential buyer.

21. The method of claim 16 wherein at least some of the buyer preference information is determined prior to the presentation of the virtual tour based on the potential buyer's interactions with at least one previous virtual tour of a different real estate property.
